(19) United States
(12) Patent Application Publication
(10) Pub. No.: US 2017/0073023 A1
(43) Pub. Date: Mar. 16, 2017

(54) TRUCK TAILGATE ACCESSORY

(71) Applicant: Jeremy Feight, Hustontown, PA (US)

(72) Inventor: Jeremy Feight, Hustontown, PA (US)

(21) Appl. No.: 14/851,079

(22) Filed: Sep. 11, 2015

(51) Int. Cl. B62D 33/02

(52) U.S. Cl. CPC B62D 33/0207

(57) ABSTRACT

A truck tailgate accessory is disclosed, which includes a support platform configured and arranged to rest upon a tailgate of a pickup truck when the tailgate is lowered. The support platform may comprise a main member and a cross member intersecting the main member forming a cross shape, although other shaped may be formed. A vertical member depends from an end of the support platform. A striker extends from the vertical member and is configured and arranged to engage a latch on the tailgate whereby the support platform is selectively locked to the tailgate. A tool component, such as an adjustable clamp, may be mounted to the support platform at any of a number of mounting points.

### BACKGROUND OF THE INVENTION

1. Field of the Invention

This patent document relates generally to accessories for pickup trucks and more particularly to a tailgate accessory for a pickup truck.

2. Background of the Related Art

The tailgate of a pickup truck, when lowered, is used for work and recreation, serving as a makeshift platform for workers and party-goers alike. However, the tailgate alone does not provide an optimal and stable platform in itself. A tailgate frequently has an uneven surface and does not provide an adequate means to secure a work piece or anchor a grill or portable canopy, for instance. Therefore, there is a perceived need in the prior art for a device or mechanism to provide a stable and secure surface on a tailgate of a pickup truck

### SUMMARY OF THE INVENTION

The tailgate accessory described herein solves the problems of the prior art by providing a support platform configured and arranged to rest upon a tailgate of a pickup truck when the tailgate is lowered. The support platform includes a vertical member depending from the support platform and a striker extending from the vertical member configured and arranged to engage a latch on the tailgate whereby the support platform is selectively locked to the tailgate. The support platform may further comprise a main member and a cross member intersecting the main member forming a cross shape, and further include height-adjustable or leveling feet. A tool component, such as a clamp, may be selectively attached to a number of mounting points on the support platform to provide additional functionality to the platform. For instance, an adjustable clamp may be used to hold a work piece or anchor a portable canopy in place. The support platform may be further anchored to the truck tailgate with an optional tie down strap.

### BRIEF DESCRIPTION OF THE DRAWINGS

These and other features, aspects, and advantages of the present invention will become better understood with reference to the following description, appended claims, and accompanying drawings where:

FIG. 1 is a top perspective view of an embodiment of the truck tailgate accessory with a clamp in a first position;

FIG. 2 is a top perspective view of an embodiment of the truck tailgate accessory with a clamp in a second position;

FIG. 3 is a bottom perspective view of an embodiment of the truck tailgate accessory;

FIG. 4 is a right side elevation view of an embodiment of the truck tailgate accessory;

FIG. 5 is a perspective view showing an embodiment of the truck tailgate accessory mounted on a tailgate of a pickup truck; and

FIG. 6 is a close up view showing an embodiment of the tailgate accessory engaged with the tailgate lock.

### DESCRIPTION OF THE PREFERRED EMBODIMENT

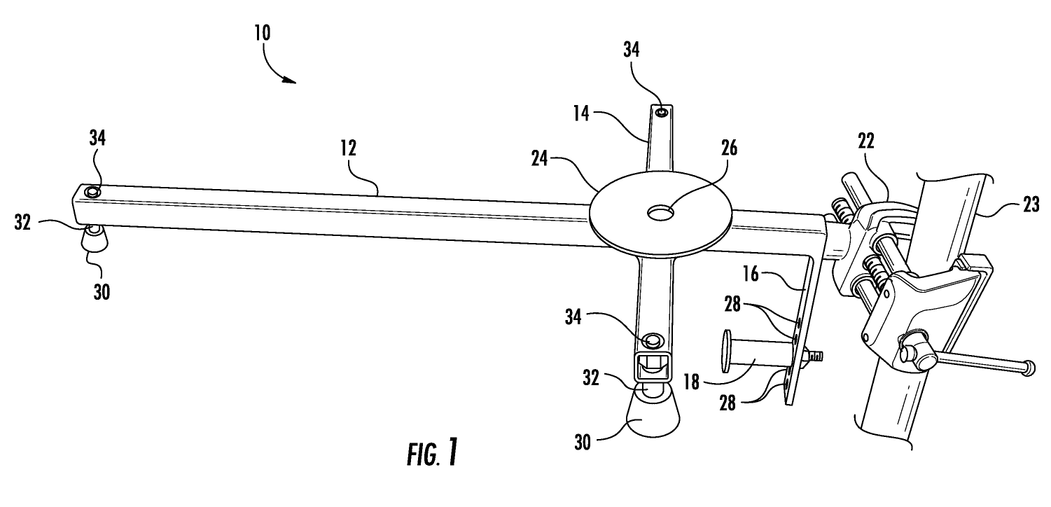

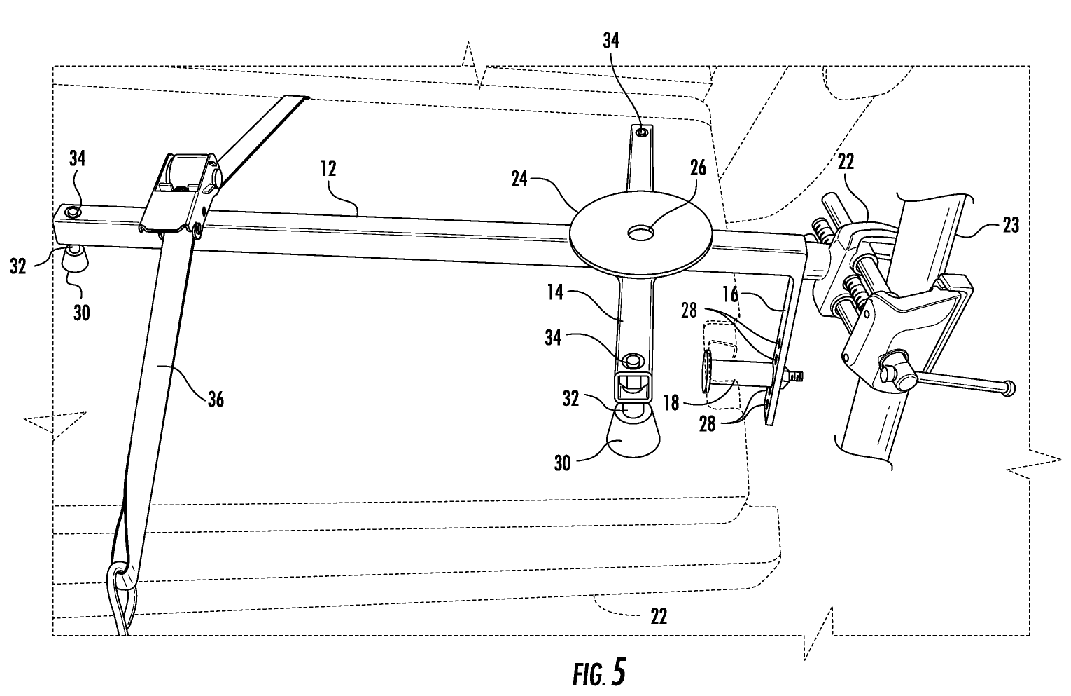

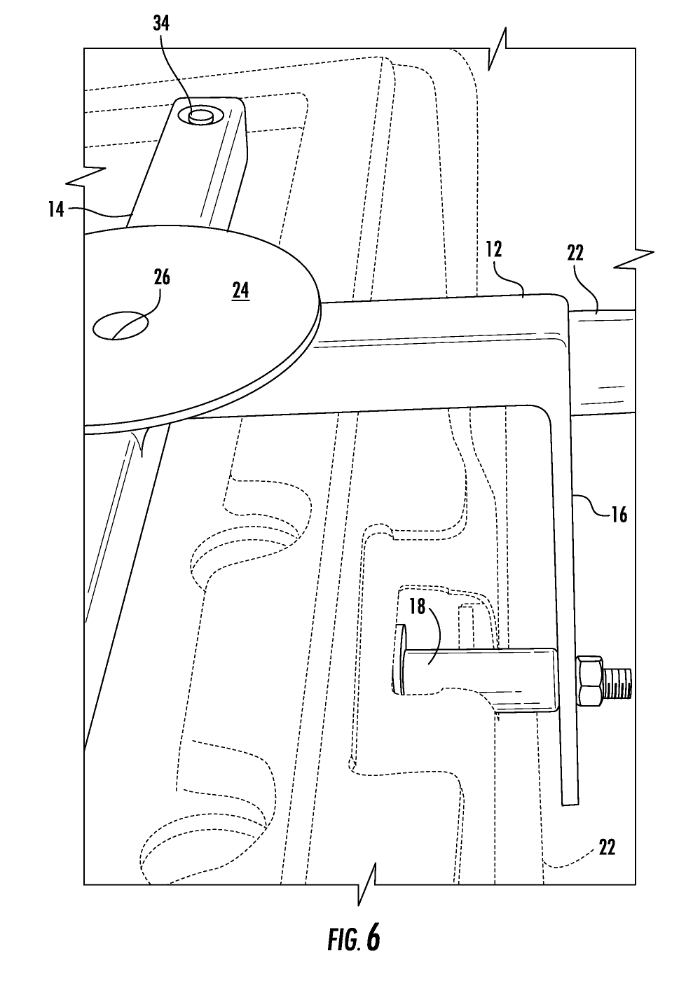

Referring now to FIGS. 1-4, an embodiment of the truck tailgate accessory is shown generally at 10. The truck tailgate assembly generally includes a support platform formed by a main member 12 intersected with a cross member 14, forming a cross-shape. A vertical member 16 depends from one end of the main member 12 and includes a striker 18 extending from inwardly from an end thereof, which is configured to lock to a latch on the tailgate 20 (best illustrated in FIGS. 5 and 6). In this manner the truck tailgate assembly 10 is held in a fixed position on the tailgate 20 of the pickup truck, proving a stable platform for a tool component, such as an adjustable clamp 22 which can be used to secure a structure or object 23 to the tailgate 22 (best illustrated in FIG. 1).

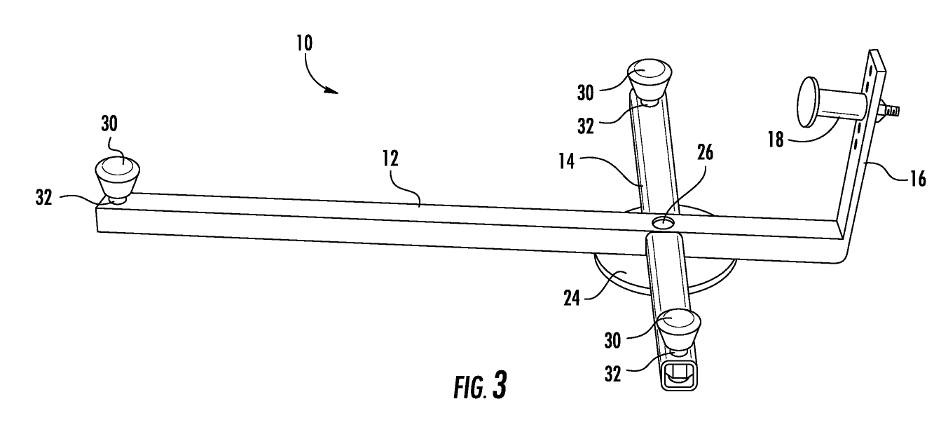

The main member 12 and cross member 14 may be formed from tubular steel with a square cross-section for added strength and rigidity although other materials and cross-sectional shapes may be used. The cross member 14 may comprise to separate sections connected to either side of the main member 12 (best seen in FIG. 3). The main member 12 and cross member 14 may be welded together. The support platform may further include a plate 24 attached to a top surface of the support platform at the intersection of the main member 12 and cross member 14, which may be further welded for added strength and rigidity.

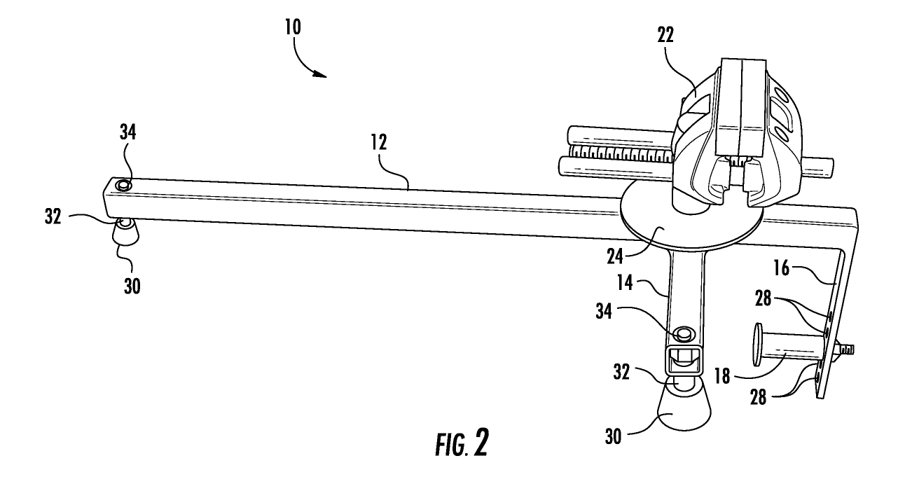

A mounting point may be formed through a top surface of the support platform. In one embodiment, the mounting point may be an aperture 26 formed through the plate 24 and intersection of the main member 12 and cross member 14. The aperture 26 permits the tool component 22 to be connected thereto as shown in FIG. 2. Similarly, another mounting point may be formed on an end of the main member 12 providing an alternate placement of the tool component as shown in FIG. 1 where the clamp 22 is secured against the plate 24.

The vertical member 16 may include a number of apertures 28 therethrough, providing flexibility in adjusting the height of the striker 18 on the vertical member 16, allowing the truck tailgate assembly 10 to fit a variety of make and models of trucks. The striker 18 includes a generally cylindrical shape with a flattened end to prevent the striker 18 from dislodging from the tailgate latch. Extending from the cylindrical shape is a fastening mechanism, such as a threaded post with a nut and optional washer, permitting the striker 18 to be easily removed and reconnected to the vertical member 16.

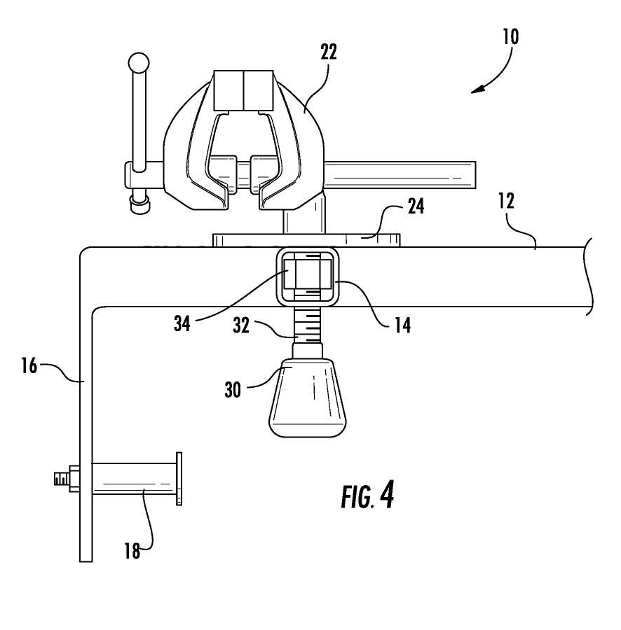

The support platform may further include height adjustable feet 30 depending from a bottom of the support platform to enable a user to level the support platform and provide a finer grain of height adjustment of the striker 18 relative to the tailgate latch. In one embodiment, the adjustable feet 30 each has a threaded rod 32 received into a threaded aperture 34 on the ends of the main member 12 and cross member 14, respectively. Best seen in FIG. 4, the threaded aperture 34 may be formed by welding a threaded nut within the cross member 14 and main member 12. Alternatively, the threaded aperture 34 may be formed by boring and taping a through hole directly in the main member 12 and cross member 14.

To provide additional stability, a strap 36 may be secured around the main member 12 and the tailgate 22 of the truck.

Therefore, it can be seen that the present invention provides a unique solution to the problem of enhancing the stability and functionality of a truck tailgate by providing a support platform that may be augmented with tool components, such as an adjustable clamp.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A truck tailgate accessory, comprising:
a support platform configured and arranged to rest upon a tailgate of a pickup truck when the tailgate is lowered;
a vertical member depending from the support platform; and
a striker extending from the vertical member configured and arranged to engage a latch on the tailgate whereby the support platform is selectively locked to the tailgate.

2. The truck tailgate accessory of claim 1, wherein the support platform comprises a main member and a cross member intersecting the main member.

3. The truck tailgate accessory of claim 2, wherein the intersection of the main member and cross member forms a cross shape.

4. The truck tailgate accessory of claim 2, wherein the cross member is formed from two separate pieces connected on opposite sides of the main member.

5. The truck tailgate accessory of claim 2, further comprising a plate connected to the main member and cross member at the intersection thereof.

6. The truck tailgate accessory of claim 1, further comprising feet depending from the bottom of the support platform.

7. The truck tailgate accessory of claim 6, wherein the feet are height adjustable.

8. The truck tailgate accessory of claim 1, further comprising a tool component selectively attachable to the support platform.

9. The truck tailgate accessory of claim 8, wherein the tool component is attachable to a top of the support platform.

10. The truck tailgate accessory of claim 8, wherein the tool component is attachable to an end of the support platform.

11. The truck tailgate accessory of claim 8, wherein the tool component comprises an adjustable clamp.

12. The truck tailgate accessory of claim 1, further comprising a fastening strap configured and arranged to tie down the support platform to the tailgate.

13. A truck tailgate accessory, comprising:
a support platform configured and arranged to rest upon a tailgate of a pickup truck when the tailgate is lowered, the support platform comprising a main member and a cross member intersecting the main member forming a cross shape;
a vertical member depending from an end of the main member support platform; and
a striker extending from the vertical member configured and arranged to engage a latch on the tailgate whereby the support platform is selectively locked to the tailgate.

14. The truck tailgate accessory of claim 13, further comprising a plate connected to the main member and cross member at the intersection thereof.

15. The truck tailgate accessory of claim 13, further comprising height adjustable feet depending from the bottom of the support platform.

16. The truck tailgate accessory of claim 13, further comprising an adjustable clamp configured and arranged to attached to the support platform.

17. The truck tailgate accessory of claim 13, further comprising a fastening strap configured and arranged to tie down the support platform to the tailgate.
